(19) United States
(12) Patent Application Publication
(10) Pub. No.: US 2025/0261142 A1
(43) Pub. Date: Aug. 14, 2025

(54) MANAGING DISTRIBUTED RADIO RESOURCES

(71) Applicant: Nokia Solutions and Networks Oy, Espoo (FI)

(72) Inventors: Ville Petteri PÖYHÖNEN, Espoo (FI); Janne Einari TUONONEN, Espoo (FI); Kimmo KETTUNEN, Espoo (FI)

(21) Appl. No.: 19/114,984

(22) PCT Filed: Sep. 30, 2022
(86) PCT No.: PCT/EP2022/077384

§ 371 Date: Mar. 25, 2025

(51) Int. Cl. H04W 56/00; H04W 76/28

(52) U.S. Cl. CPC H04W 56/001; H04W 76/28

(57) ABSTRACT

Disclosed is a method comprising determining, for a terminal device, a connection path, wherein the connection path comprises multiple radio links connecting an overlaying network and a subnetwork, and wherein the terminal device is comprised in the subnetwork, obtaining a management scheme for co-ordinating radio resource usage of the multiple radio links, and causing radio resource control states of the radio links to be synchronized in accordance with the management scheme.

### FIELD

The following exemplary embodiments relate to wireless communication and managing distributed radio resources.

### BACKGROUND

Wireless communication networks, such as cellular communication networks evolve, and may be utilized for various purposes including Internet of Things (IoT). Also, subnetworks, which may function at least partly in an autonomous manner provide various opportunities for various environments to improve connectivity. To manage radio resources efficiently in such environments is thus desirable.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising means for: determining, for a terminal device, a connection path, wherein the connection path comprises multiple radio links connecting an overlaying network and a subnetwork, and wherein the terminal device is comprised in the subnetwork, obtaining a management scheme for co-ordinating radio resource usage of the multiple radio links, and causing radio resource control states of the radio links to be synchronized in accordance with the management scheme.

In some example embodiments according to the first aspect, the means comprises at least one processor, and at least one memory, including a computer program code, wherein the at least one memory and the computer program code are configured, with the at least one processor, to cause the performance of the apparatus.

According to a second aspect there is provided an apparatus comprising at least one processor, and at least one memory including a computer program code, wherein the at least one memory and the computer program code are configured, with the at least one processor, to cause the apparatus to: determine, for a terminal device, a connection path, wherein the connection path comprises multiple radio links connecting an overlaying network and a subnetwork, and wherein the terminal device is comprised in the subnetwork, obtain a management scheme for co-ordinating radio resource usage of the multiple radio links, and cause radio resource control states of the radio links to be synchronized in accordance with the management scheme.

According to a third aspect there is provided a method comprising: determining, for a terminal device, a connection path, wherein the connection path comprises multiple radio links connecting an overlaying network and a subnetwork, and wherein the terminal device is comprised in the subnetwork, obtaining a management scheme for co-ordinating radio resource usage of the multiple radio links, and causing radio resource control states of the radio links to be synchronized in accordance with the management scheme.

In some example embodiments according to the third aspect, the method is a computer-implemented method.

According to a fourth aspect there is provided a computer program comprising instructions for causing an apparatus to perform at least the following: determine, for a terminal device, a connection path, wherein the connection path comprises multiple radio links connecting an overlaying network and a subnetwork, and wherein the terminal device is comprised in the subnetwork, obtain a management scheme for co-ordinating radio resource usage of the multiple radio links, and cause radio resource control states of the radio links to be synchronized in accordance with the management scheme.

According to a fifth aspect there is provided a computer program comprising instructions stored thereon for performing at least the following: determining, for a terminal device, a connection path, wherein the connection path comprises multiple radio links connecting an overlaying network and a subnetwork, and wherein the terminal device is comprised in the subnetwork, obtaining a management scheme for co-ordinating radio resource usage of the multiple radio links, and causing radio resource control states of the radio links to be synchronized in accordance with the management scheme.

According to a sixth aspect there is provided a non-transitory computer readable medium comprising program instructions for causing an apparatus to perform at least the following: determine, for a terminal device, a connection path, wherein the connection path comprises multiple radio links connecting an overlaying network and a subnetwork, and wherein the terminal device is comprised in the subnetwork, obtain a management scheme for co-ordinating radio resource usage of the multiple radio links, and cause radio resource control states of the radio links to be synchronized in accordance with the management scheme.

According to a seventh aspect there is provided a non-transitory computer readable medium comprising program instructions stored thereon for performing at least the following: determining, for a terminal device, a connection path, wherein the connection path comprises multiple radio links connecting an overlaying network and a subnetwork, and wherein the terminal device is comprised in the subnetwork, obtaining a management scheme for co-ordinating radio resource usage of the multiple radio links, and causing radio resource control states of the radio links to be synchronized in accordance with the management scheme.

According to an eighth aspect there is provided a computer readable medium comprising program instructions stored thereon for performing at least the following: determining, for a terminal device, a connection path, wherein the connection path comprises multiple radio links connecting an overlaying network and a subnetwork, and wherein the terminal device is comprised in the subnetwork, obtaining a management scheme for co-ordinating radio resource usage of the multiple radio links, and causing radio resource control states of the radio links to be synchronized in accordance with the management scheme.

According to a ninth aspect there is provided an apparatus comprising means for: obtaining a first data, wherein the first data comprises information regarding radio resource usage in a first network, obtaining a second data, wherein the second data comprises information regarding radio resource usage in a second network, wherein the second network is different compared with the first network, determining, based on the first data and the second data, usage patterns respective to the first network and the second network, creating, based on the usage patterns and a management profile, wherein the management profile defines an overall usage pattern of a plurality of networks, a first management scheme for the first network and a second management scheme for the second network, and distributing the first management scheme to the first network and the second management scheme to the second network.

In some example embodiments according to the ninth aspect, the means comprises at least one processor, and at least one memory, including a computer program code, wherein the at least one memory and the computer program code are configured, with the at least one processor, to cause the performance of the apparatus.

According to a tenth aspect there is provided an apparatus comprising at least one processor, and at least one memory including a computer program code, wherein the at least one memory and the computer program code are configured, with the at least one processor, to cause the apparatus to: obtain a first data, wherein the first data comprises information regarding radio resource usage in a first network, obtain a second data, wherein the second data comprises information regarding radio resource usage in a second network, wherein the second network is different compared with the first network, determine, based on the first data and the second data, usage patterns respective to the first network and the second network, create, based on the usage patterns and a management profile, wherein the management profile defines an overall usage pattern of a plurality of networks, a first management scheme for the first network and a second management scheme for the second network, and distribute the first management scheme to the first network and the second management scheme to the second network.

According to an eleventh aspect there is provided a method comprising: obtaining a first data, wherein the first data comprises information regarding radio resource usage in a first network, obtaining a second data, wherein the second data comprises information regarding radio resource usage in a second network, wherein the second network is different compared with the first network, determining, based on the first data and the second data, usage patterns respective to the first network and the second network, creating, based on the usage patterns and a management profile, wherein the management profile defines an overall usage pattern of a plurality of networks, a first management scheme for the first network and a second management scheme for the second network, and distributing the first management scheme to the first network and the second management scheme to the second network.

In some example embodiments according to the eleventh aspect, the method is a computer-implemented method.

According to a twelfth aspect there is provided a computer program comprising instructions for causing an apparatus to perform at least the following: obtain a first data, wherein the first data comprises information regarding radio resource usage in a first network, obtain a second data, wherein the second data comprises information regarding radio resource usage in a second network, wherein the second network is different compared with the first network, determine, based on the first data and the second data, usage patterns respective to the first network and the second network, create, based on the usage patterns and a management profile, wherein the management profile defines an overall usage pattern of a plurality of networks, a first management scheme for the first network and a second management scheme for the second network, and distribute the first management scheme to the first network and the second management scheme to the second network.

According to a thirteenth aspect there is provided a computer program comprising instructions stored thereon for performing at least the following: obtaining a first data, wherein the first data comprises information regarding radio resource usage in a first network, obtaining a second data, wherein the second data comprises information regarding radio resource usage in a second network, wherein the second network is different compared with the first network, determining, based on the first data and the second data, usage patterns respective to the first network and the second network, creating, based on the usage patterns and a management profile, wherein the management profile defines an overall usage pattern of a plurality of networks, a first management scheme for the first network and a second management scheme for the second network, and distributing the first management scheme to the first network and the second management scheme to the second network.

According to a fourteenth aspect there is provided a non-transitory computer readable medium comprising program instructions for causing an apparatus to perform at least the following: obtain a first data, wherein the first data comprises information regarding radio resource usage in a first network, obtain a second data, wherein the second data comprises information regarding radio resource usage in a second network, wherein the second network is different compared with the first network, determine, based on the first data and the second data, usage patterns respective to the first network and the second network, create, based on the usage patterns and a management profile, wherein the management profile defines an overall usage pattern of a plurality of networks, a first management scheme for the first network and a second management scheme for the second network, and distribute the first management scheme to the first network and the second management scheme to the second network.

According to a fifteenth aspect there is provided a non-transitory computer readable medium comprising program instructions stored thereon for performing at least the following: obtaining a first data, wherein the first data comprises information regarding radio resource usage in a first network, obtaining a second data, wherein the second data comprises information regarding radio resource usage in a second network, wherein the second network is different compared with the first network, determining, based on the first data and the second data, usage patterns respective to the first network and the second network, creating, based on the usage patterns and a management profile, wherein the management profile defines an overall usage pattern of a plurality of networks, a first management scheme for the first network and a second management scheme for the second network, and distributing the first management scheme to the first network and the second management scheme to the second network.

According to a sixteenth aspect there is provided a computer readable medium comprising program instructions stored thereon for performing at least the following: obtaining a first data, wherein the first data comprises information regarding radio resource usage in a first network, obtaining a second data, wherein the second data comprises information regarding radio resource usage in a second network, wherein the second network is different compared with the first network, determining, based on the first data and the second data, usage patterns respective to the first network and the second network, creating, based on the usage patterns and a management profile, wherein the management profile defines an overall usage pattern of a plurality of networks, a first management scheme for the first network and a second management scheme for the second network, and distributing the first management scheme to the first network and the second management scheme to the second network.

According to a seventeenth aspect there is provided an apparatus comprising means for: obtaining information regarding a management scheme, wherein the management scheme is for co-ordinating radio resource usage of multiple radio links within a network and the apparatus resides in the network, synchronizing radio resource control state of a first radio link, from the apparatus to a communication point, in accordance with the obtained management scheme, and transmitting data using a communication path that comprises the first radio link and at least one other radio link and wherein the communication path connects the network to an overlaying network.

In some example embodiments according to the seventeenth aspect, the means comprises at least one processor, and at least one memory, including a computer program code, wherein the at least one memory and the computer program code are configured, with the at least one processor, to cause the performance of the apparatus.

According to an eighteenth aspect there is provided an apparatus comprising at least one processor, and at least one memory including a computer program code, wherein the at least one memory and the computer program code are configured, with the at least one processor, to cause the apparatus to: obtain information regarding a management scheme, wherein the management scheme is for co-ordinating radio resource usage of multiple radio links within a network and the apparatus resides in the network, synchronize radio resource control state of a first radio link, from the apparatus to a communication point, in accordance with the obtained management scheme, and transmit data using a communication path that comprises the first radio link and at least one other radio link and wherein the communication path connects the network to an overlaying network.

According to a nineteenth aspect there is provided a method comprising: obtaining information regarding a management scheme, wherein the management scheme is for co-ordinating radio resource usage of multiple radio links within a network and the apparatus resides in the network, synchronizing radio resource control state of a first radio link, from the apparatus to a communication point, in accordance with the obtained management scheme, and transmitting data using a communication path that comprises the first radio link and at least one other radio link and wherein the communication path connects the network to an overlaying network.

In some example embodiments according to the nineteenth aspect, the method is a computer-implemented method.

According to a twentieth aspect there is provided a computer program comprising instructions for causing an apparatus to perform at least the following: obtain information regarding a management scheme, wherein the management scheme is for co-ordinating radio resource usage of multiple radio links within a network and the apparatus resides in the network, synchronize radio resource control state of a first radio link, from the apparatus to a communication point, in accordance with the obtained management scheme, and transmit data using a communication path that comprises the first radio link and at least one other radio link and wherein the communication path connects the network to an overlaying network.

According to a twenty first aspect there is provided a computer program comprising instructions stored thereon for performing at least the following: obtaining information regarding a management scheme, wherein the management scheme is for co-ordinating radio resource usage of multiple radio links within a network and the apparatus resides in the network, synchronizing radio resource control state of a first radio link, from the apparatus to a communication point, in accordance with the obtained management scheme, and transmitting data using a communication path that comprises the first radio link and at least one other radio link and wherein the communication path connects the network to an overlaying network.

According to a twenty second aspect there is provided a non-transitory computer readable medium comprising program instructions for causing an apparatus to perform at least the following: obtain information regarding a management scheme, wherein the management scheme is for co-ordinating radio resource usage of multiple radio links within a network and the apparatus resides in the network, synchronize radio resource control state of a first radio link, from the apparatus to a communication point, in accordance with the obtained management scheme, and transmit data using a communication path that comprises the first radio link and at least one other radio link and wherein the communication path connects the network to an overlaying network.

According to a twenty third aspect there is provided a non-transitory computer readable medium comprising program instructions stored thereon for performing at least the following: obtaining information regarding a management scheme, wherein the management scheme is for co-ordinating radio resource usage of multiple radio links within a network and the apparatus resides in the network, synchronizing radio resource control state of a first radio link, from the apparatus to a communication point, in accordance with the obtained management scheme, and transmitting data using a communication path that comprises the first radio link and at least one other radio link and wherein the communication path connects the network to an overlaying network.

According to twenty fourth aspect there is provided a computer readable medium comprising program instructions stored thereon for performing at least the following: obtaining information regarding a management scheme, wherein the management scheme is for co-ordinating radio resource usage of multiple radio links within a network and the apparatus resides in the network, synchronizing radio resource control state of a first radio link, from the apparatus to a communication point, in accordance with the obtained management scheme, and transmitting data using a communication path that comprises the first radio link and at least one other radio link and wherein the communication path connects the network to an overlaying network.

According to twenty fifth aspect there is provided a system comprising at least a first network, a first terminal device in the first network, a second network and a second terminal device comprised in the second network, and wherein the system is configured to: obtain a first data, wherein the first data comprises information regarding radio resource usage in the first network, obtain a second data, wherein the second data comprises information regarding radio resource usage in the second network, determine, based on the first data and the second data, usage patterns respective to the first network and the second network, create, based on the usage patterns and a management profile, wherein the management profile defines an overall usage pattern of a plurality of networks, a first management scheme for the first network, and a second management scheme for the second network, distribute the first management scheme to the first network and the second management scheme to the second network, synchronize, by the first network, radio resource control states of radio links comprised in the first network in accordance with the first management scheme, synchronize, by the second network, radio resource control states of radio links comprised in the second network in accordance with the second management scheme, and transmit, by the first terminal device, a data transmission to the second terminal device using a communication path comprising multiple radio links connecting the first network and the second network.

### LIST OF DRAWINGS

In the following, the invention will be described in greater detail with reference to the embodiments and the accompanying drawings, in which

FIG. 1 illustrates an example embodiment of a radio access network.

FIG. 2 illustrates an example embodiment regarding a sub-network.

FIG. 3A illustrates an example embodiment of radio links.

FIG. 3B and FIG. 3C illustrate example embodiments of harmonizing operations of a radio interface.

FIG. 4 illustrates an example embodiment of performing resource management decisions per radio link.

FIG. 5 illustrates an example embodiment of distributed management method from an overall perspective.

FIG. 6 and FIG. 7 illustrate example embodiments of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

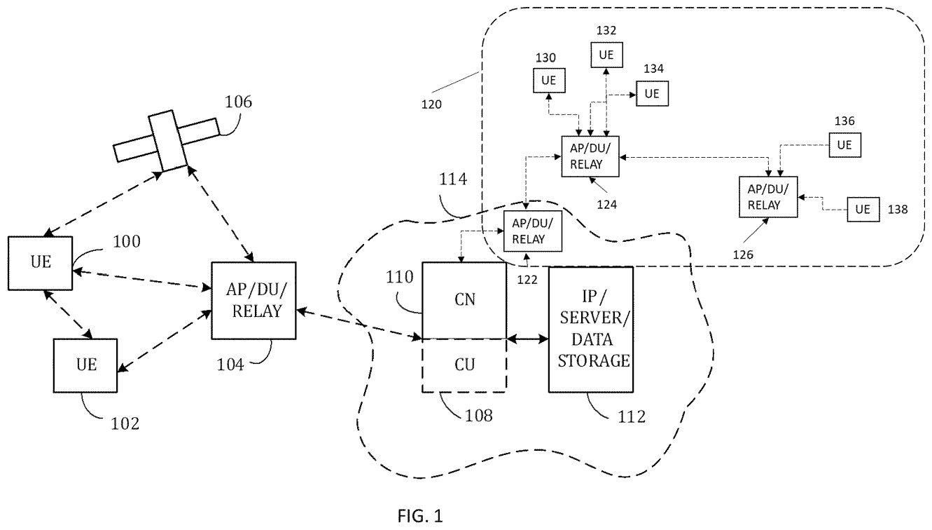

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node. The wireless link from a terminal device to a (e/g)NodeB is called uplink or reverse link and the wireless link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

Additionally, there may be overlayed a so-called sub-network 120, which may comprise one or more access nodes with federated gateway functionalities and terminal devices that are connected to those one or more access nodes. In this example embodiment, there are terminal devices 130, 132, 134 136 and 138 comprised in the subnetwork 120. Terminal devices 130, 132 and 134 are connected to the access node 124 and the terminal devices 136 and 138 are connected to the access node 126. The access nodes 124 and 126 are chained as they are connected to each other and the access node 124 is then connected to the access node 122, which is then connected to the cores network 110. The access nodes 122, 124 and 126 are access nodes that are comprised in the subnetwork 120.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require bringing the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling or service availability in areas that do not have terrestrial coverage. Satellite communication may utilise geostationary earth orbit (GEO) satellite systems, but also low earth orbit (LEO) satellite systems, for example, mega-constellations. A satellite 106 comprised in a constellation may carry a gNB, or at least part of the gNB, that create on-ground cells. Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication, distributed ledgers and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

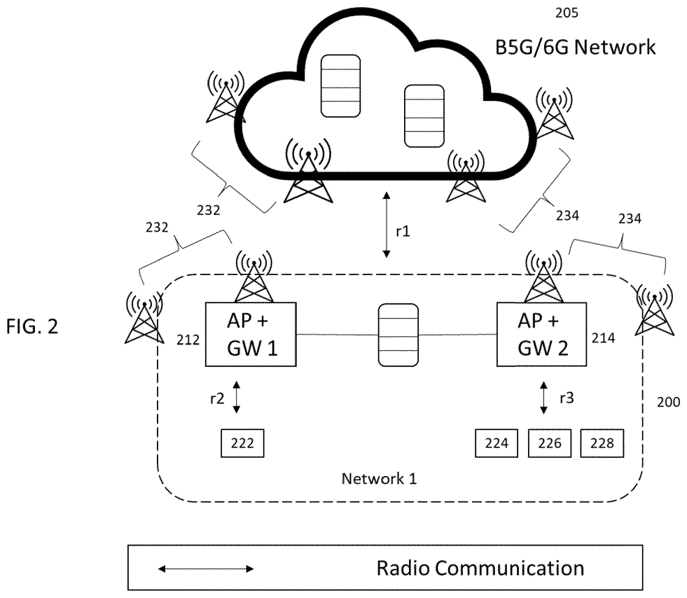

FIG. 2 illustrates an example embodiment in which there is a 6G subnetwork 200 illustrated. There may be one or more terminal devices comprised in the subnetwork 200 and the terminal devices are in this example embodiment connected to the access points 212 and 214. The access points 212 and 214 are capable of performing federated gateway (GW) functionality. In this example embodiment, the subnetwork 200 is connected to overlay beyond 5G (B5G)/6G network 205 via B5G/6G radio interface as illustrated by radio link r1. The B5G/6G radio interface may not need to be seamless or continuous, however. Yet, in this example embodiment, the subnetwork 200 is capable to operate autonomously with some controlled service degradation being acceptable when the subnetwork 200 is out-of-coverage of the overlay network 205.

In this example embodiment, terminal devices comprised in the subnetwork 200 also utilize B5G/6G radio to access federated GW functionality and to communicate one to another using this same radio (via GWs). This means that on the end-to-end (E2E) path there can be multiple successive B5G/6G radio links r1, r2 and r3. Radio Resource Control (RRC) protocol, such as 5G NR RRC, comprises three RRC states: RRC_IDLE, RRC_INACTIVE and RRC_CONNECTED. In the subnetwork 200, also Discontinuous Reception (DRX) may be utilized. DRX may be of two types: Idle mode DRX and Connected mode DRX. In Idle mode DRX, the UE periodically wakes up to monitor for paging messages and goes back to sleep mode if paging message is not intended for it. The connected mode DRX (cDRX) allows to reduce battery power consumption in a terminal device by allowing the terminal device to periodically enter a state in which physical downlink control channel (PDCCH) is not monitored. This state may last for a pre-determined time period that may be referred to as an OFF period. Then for monitoring PDCCH downlink/uplink data, the terminal device may periodically wake up and be in a wake-up mode for another pre-determined time period, which may be understood as an ON period. The ON periods and OFF periods alternate according to a pre-defined pattern thus forming a DRX cycle.

Subnetworks may comprise multiple radio hops and if there are multiple radio hops in a connection, such as an end-to-end (E2E) connection, then power saving aspects such as those connected to DRX may cause unnecessary delays for data packets if the activity periods in different radio hops are uncoordinated. For example, if the terminal device 222 connects to the terminal device 224, there are hops r2 and r3 in the connection and thus, the activity periods of r2 and r3 are to be co-ordinated to avoid unnecessary delays. In addition, uncoordinated sequential RRC state transitions in different radio hops may cause unnecessary 1st packet delay, which should be avoided in order to achieve low service start-up times requiring fast delivery of the initial handshake messages.

As the subnetwork 200 is, in this example embodiment, a 6G subnetwork, multiple Uu-type radio interfaces are present on a communication path from a terminal device to a network. As there may be multiple terminal devices present in the subnetwork 200, there may also be multiple communication paths with multiple radio links. Thus, distributed radio resources along the communication paths with multiple radio links are to be managed in a unified manner to ensure fast communication path establishment and optimized and sustainable radio resource utilization. As an E2E connection may comprise communication sessions over multiple radio bearers, communication sessions are to be managed in view of crossing those bearers one by one. As the radios support power and signalling optimizations such as paging and DRX, their management for a given communication path or pattern may be performed in a co-ordinated manner. Having predictability allows to carry out management operations pro-actively according to preferred optimization goal. Communication pattern may be understood to refer to a multitude of point-to-point communication sessions.

In this example embodiment, the subnetwork 200 comprises four terminal devices 222, 224, 226 and 228. The access points 212 and 214 are respectively related to radios 232 and 234 and the radios are different from each other. The terminal devices 222-228 are communicating with each other, with the overlaying network 205 and with services beyond the network 205 in public Internet. Radio links relevant for the communications of the terminal devices are marked as r1, r2, and r3. Additionally, there may be other type of traffic that requires that the radio links are active like for instance Control Plane (CP) traffic between B5G/6G network 205 and the access points 212 and 214.

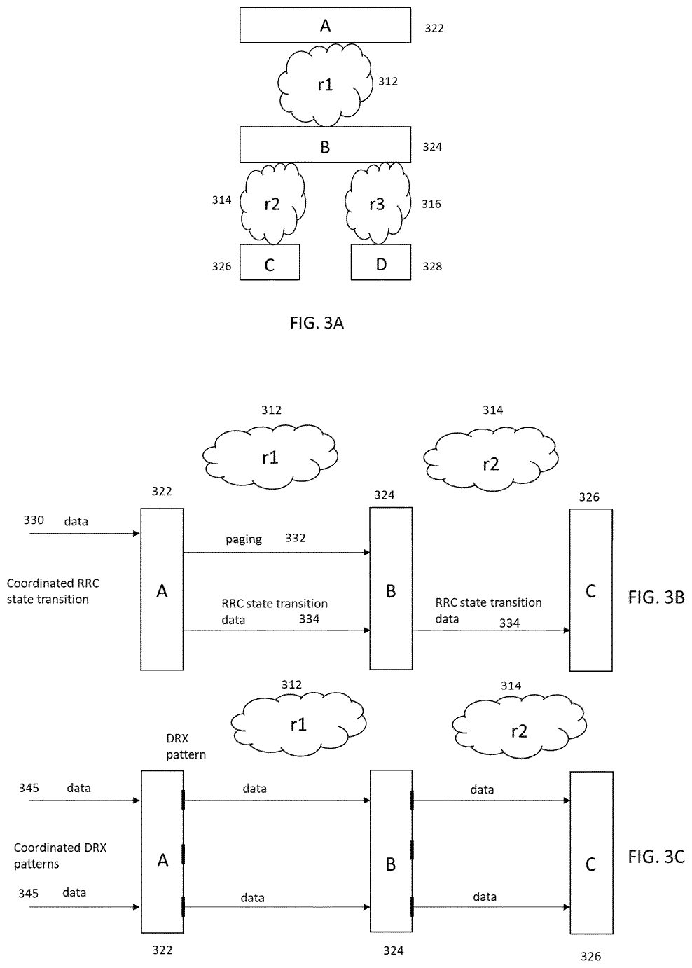

FIG. 3A illustrates an example embodiment of radio links, 312, 314 and 316, which may be radio links such as r1, r2 and r3 illustrated in the example embodiment of FIG. 2, and communication points 322, 324, 326 and 328 around them. The communication points 322, 324, 326 and 328 may be for example the terminal devices 222-228 illustrated in FIG. 2. In this example embodiment, communication between communication point 326 and 328 is to go via communication point 324. This may be a limitation introduced from the environment, which in this example embodiment is the environment illustrated in FIG. 2. In this example embodiment, this limitation is due to inter-device communication between the terminal devices 222-228 is done based on radio links provided by the access point 212 and 214 and the gateway functionality performed by the access points 212 and 214. As such, any communication crossing two communication points requires at least 1 active radio link (312, 314 or 316) between the communication points. As multiple radio links are to be used, a co-operative radio resource management is beneficial. Further, in this example embodiment, in communication points 322 and 324 radio resource management may be performed locally. Although in the communication points 322 and 324 radio resource management operations may be executed, trigger(s) and other related instructions that initiate them may come from elsewhere.

FIG. 3B illustrates an example embodiment of a co-ordinated RRC state transition, which may be understood as harmonizing operations of a radio interface. In this example embodiment, RRC state transitions between radio links 312 and 314 are co-ordinated to expedite the first data packet 330 arriving from overlay network, such as the overlay network 205 of FIG. 2, to communication points 322, 324 and 326. The co-ordination may be achieved using paging 332 from communication point 322 towards the communication point 334 and by transmitting RRC state transition data 334 from the communication point 322 towards the communication point 324 and RRC state transition data 336 from the communication point 324 towards the communication points 326.

FIG. 3C illustrates an example embodiment of a co-ordinated DRX patterns, which may also be understood as harmonizing operations of a radio interface. Co-ordinated DRX patterns ensure that when the data 345 is flowing and both radio links 312 and 314 are in RRC connected mode, the DRX patterns used in radio links 312 and 314 are such that minimize the waiting delay at communication point 324. It is to be noted that minimizing the waiting delay may be understood also as optimizing transmission time of data transmission. Further, in some example embodiments, minimizing the delay may be within certain limits, in other words the delay is to be between certain threshold times. This may be beneficial for taking into account power saving requirements as well.

Communication points 322 and 324 also represent the points in the network topology where it is possible to closely observe on what happens on local radio links and their usage. For example, in the communication point 324 communication patterns of the local network may be observed. This may be beneficial as many of the local services may run in the access points that are capable of performing gateway functionalities, or next to them.

A subnetwork, such as subnetwork 200, may locate in a remote site and may be specialised to do certain routine type of actions in timely manner. For example, a subnetwork may be a factory network or other private network. In such environments, there may be specific pre-defined roles for each terminal device, including service providers and consumers. This kind of role setting may result in distinct communication patterns matching the service usage and how computing resources are utilized. These patterns may be observed for example by the communication point 324, which may be configured to learn from the observed patterns and determined behaviour profiles, for example, by using artificial intelligence (AI)/machine learning (ML) techniques. It is to be noted that ML may be understood to cover also AI-based observation of patterns and determination of behaviour profiles. A pattern that has been determined may map to the radio resource states represented by a management scheme according to which radio resources may then be pro-actively managed to ensure that unnecessary paging, and other management operations that are invoked by communication sessions establishment request, can be avoided. Instead, radio links may be managed, in a timely manner, to prepare them for any new communication sessions establishment requests for using local or global services. If a subnetwork is a moving network, such as a car comprising a local network, information regarding geography and/or route may be utilized to further fine tune the behaviour patterns. Thus, continuous learning and finetuning of the learnt pattern to find the better optimal as well as behaviour of the subnetwork may also be utilized.

In general, machine learning models may be categorized as supervised or unsupervised. Supervised models may apply what has been learned in the past using labelled examples to predict future events. A supervised algorithm may require a set of data known as training data, comprising input data and labels that are considered as the output values of machine learning algorithms. Starting from the analysis of the training data, the machine learning algorithm produces a model, such as a mathematical model, that makes predictions about the output values. After sufficient training, the model may provide accurate output values for any new input data. The accuracy of the model, that is, the adequacy of the training may be validated by techniques such as cross-validation method. When training, some part of the labelled training data is not used for training but saved for estimating the model accuracy, that is, if the model gives a correct label to an already known output value. An unsupervised algorithm in turn takes a set of data that comprises input data without labels and finds a structure in the input data, like grouping or clustering of data points. Therefore, unsupervised methods do not need a labelled input data for training in contrast to supervised methods but may learn from input data that has not been labelled. Multiple supervised machine learning models exist. For example, machine learning regression, which may be understood as regression algorithms or regression analysis, are examples of supervised machine learning. Supervised learning algorithms model dependencies and relationships between the target output and input features to predict the value for new data. Regression algorithms predict the output values based on input features from the data fed in the system.

The regression algorithm builds a model on the features of training data and the used the model to predict a value for new data. Machine learning regression may be used to identify a relationship between a dependent variable, which may be understood as the outcome value, and one or more independent variables, that may be understood as predictors. It may also be used for example to find a causal effect relationship between the variables.

In case there is no specific management scheme, which has been determined based on learnt patterns as described above, applied, then some other management schemes may be utilized. Such management schemes may be based on pre-defined management profiles expressing generic optimization approaches and goals, for example, and could be used. For example, a pre-defined management scheme may define that in case no active communication occurs in a subnetwork, then all radio links related to access points capable of performing gateway functionality, are jointly put on idle mode. Respectively, if all radio links are in idle mode and if a terminal device comprised in the subnetwork initiates new communication session, then this is observed, and a radio link is activated as soon as possible to ensure that communication to/behind the overlay network has an active path of radio links resulting faster connection setup.

A management scheme may comprise a set of timed management operations for radio resources that may then be executed, and it may also comprise a set of policies expressing resource management optimization goals. Executing of the timed management operation may be autonomous. An example goal may be that if some specific state change of one of two radio links, such as radio links r2 or r3 of FIG. 2, occurs, then do something with a third radio link such as radio link r1 within a predefined time. In addition to co-operatively adjusting radio resources, also some other communication related resources could be managed as well, e.g., transport network resources. A management scheme may be comprised of management operations for multiple radio links in the cases where the destination network has multiple radios to be managed in harmonized fashion.

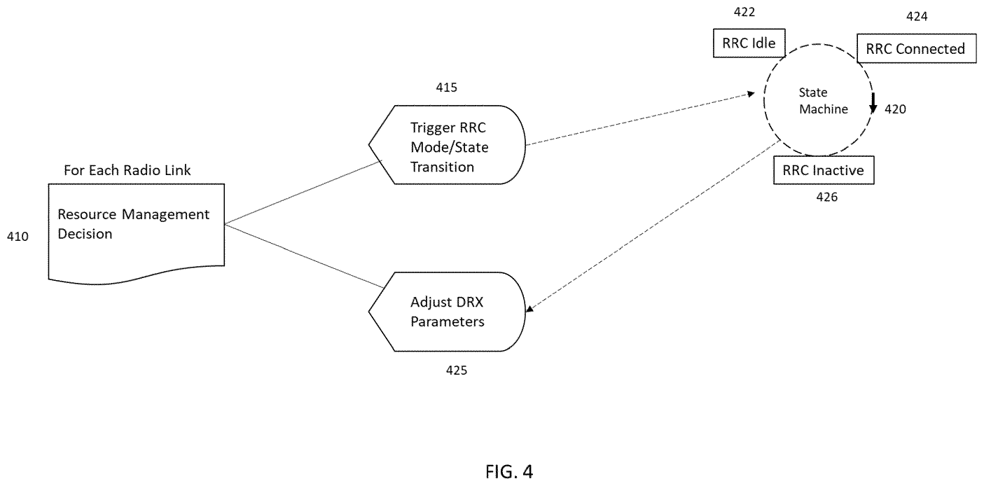

FIG. 4 illustrates an example embodiment of performing resource management decisions per radio link. A resource management decision 410 may be performed for each radio link in a setup such as that illustrated in FIG. 2. The resource management decision 410 performed per radio link may comprise both RRC mode and state transition 415 by influencing the RRC mode's state machine 420 and the adjustments of relevant DRX parameters 425 according to the current RRC mode and state. For example, some radio links may already be in the preferred RRC mode and state and therefore update is required for their DRX parameters, whereas for other radio links, it could be that also their RRC mode has to be changed to get them to the matching mode with others. The RRC States comprise RRC Idle 422, RRC Connected 424 and RRC inactive 426. The configuration of DRX parameters may not always be the same operation, and therefore the number of relevant parameters may depend on the RRC state for which the parameter values are adjusted.

In addition to the radio links present in given communication paths, also some other radio links could require resource management actions in order to achieve the global optimum. For example, in the example embodiment of FIG. 2, if the communication path for the optimization includes only internal radios of the subnetwork 200, i.e., r2 and r3, then depending on the active communication pattern including service type, it could be that radio link r1 could be adjusted so that energy consumption is minimized with or without including reachability consideration from the outside.

A policy may be obtained for managing a whole radio link chain for a given communication path. The unified policy may be pre-determined, and it may be based on learning the patterns of the communication radio links. The policy may be in accordance with a generic, unified policy such that the unified policy results in the same end state of each radio link, but in order to get there, different management operations might be needed depending on the starting state of the given radio link.

It is to be noted though regarding the state machine 420, that in some example embodiments 5G NR RRC has RAN notification area related limitation for the use of RRC_INACTIVE state. This state can be maintained only if the radio remains in the same RAN notification area. This limitation may introduce a new requirement for a subnetwork, such that the B5G/6G cells belonging to the subnetwork are to form one RAN notification area.

Co-operative radio resource management logic taking care of the all the radio links together with the management execution points, that is, with communication points, may be distributed, and the logic may use computational resources both in a subnetwork and in the overlaying network. The subnetwork may have a secure computing environment in its access points that are capable of performing gateway functionality, or in the connected resource pools. Also, other secure environment for the runtime may be utilized as long as the running is secure, since that is part of the overlaying network's control plane (CP).

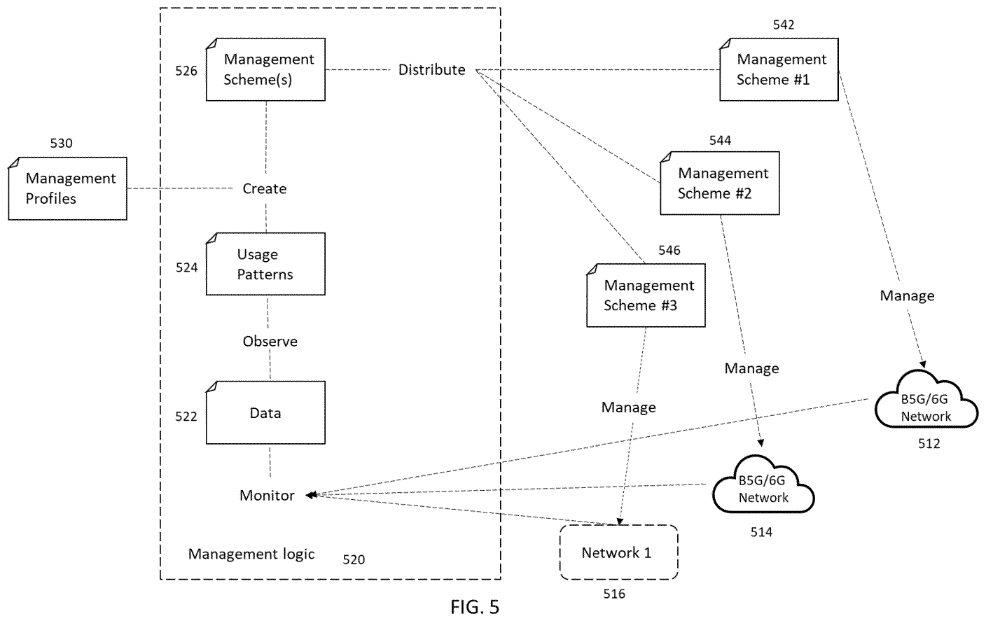

FIG. 5 illustrates an example embodiment of a distributed management method from an overall perspective. In this example embodiment there are three networks 512, 514 and 516 that are to be coordinated. Networks 512 and 514 are B5G/6G networks that are overlaying networks and network 516 is a subnetwork. The networks 512, 514 and 516 monitor internally their respective radio resource usage and collect statistics and key performance indicators (KPIs).

Then, within a management logic 520, this data 522 from multiple monitoring sources is used to observe usage patterns 524 inside networks 512, 514 and 516 and also, optionally, more widely over network boundaries that are used together with predefined management profiles 530 to create management schemes 526 for each network 512, 514 and 516 to gain a harmonized state of multi-network radio resources representing the optimal solution for a given time frame. In this example embodiment, the management scheme 542 is used to manage the network 512, the management scheme 544 is used to manage the network 514, and the management scheme 546 is used to manage the network 516. The management logic 520 may be implemented centrally or it may be distributed in any suitable manner, depending on where computational resources are available. The structure of this logic, i.e., where the related run-time entities are located topology-wise, does not need to be fixed, thus it can change over time to better respond the resource load balancing in different networks. Thus, the resulting management schemes 542, 544 and 546 comprise management instructions for each network 512, 514 and 516 to adjust their local radio resources that allows to invoke local management operations by telling what radio links to manage, how and when.

Yet, it is to be noted that the resulting management schemes 542, 544 and 546 may alternatively to instructions, comprise indications regarding a recommended state at a given time instant. As such, the management schemes may also be for indicating what is a preferred, and thus recommended, state or goal for a given radio link and when. The network may then internally determine, based on internal knowledge of the network, how to get there, in other words, how the adjusting is to be performed if the indicated recommended state is to be achieved at the given time instant. In an example embodiment in which the, one or more, management schemes comprise indications regarding a recommended state for a radio link at a given time instant, the management scheme may comprise indications regarding the one or more of the following: What to do and when, how to do it, conditional rules and/or notification rules. The what to do and when may be for example an indication that indicates that radio-X is to be in state-Y at a time instant T or modify the DRX of state-Y for radio-X. The how to do part may indicate how to perform the operations and/or modifications required for achieving the recommended state at the given time instant. It is to be noted however, that this part may be part of internal knowledge of the network and thus, in some examples, recommendations cannot be provided regarding the how to-part. The conditional rules may indicate for example that radio-X is not to go to state-Y, during time period T, or that radio-X is to stay in state-Y, during time period T. The notification rules may indicate for example that the radio-X is to notify radio-Z of RRC state changes due to incoming paging for example.

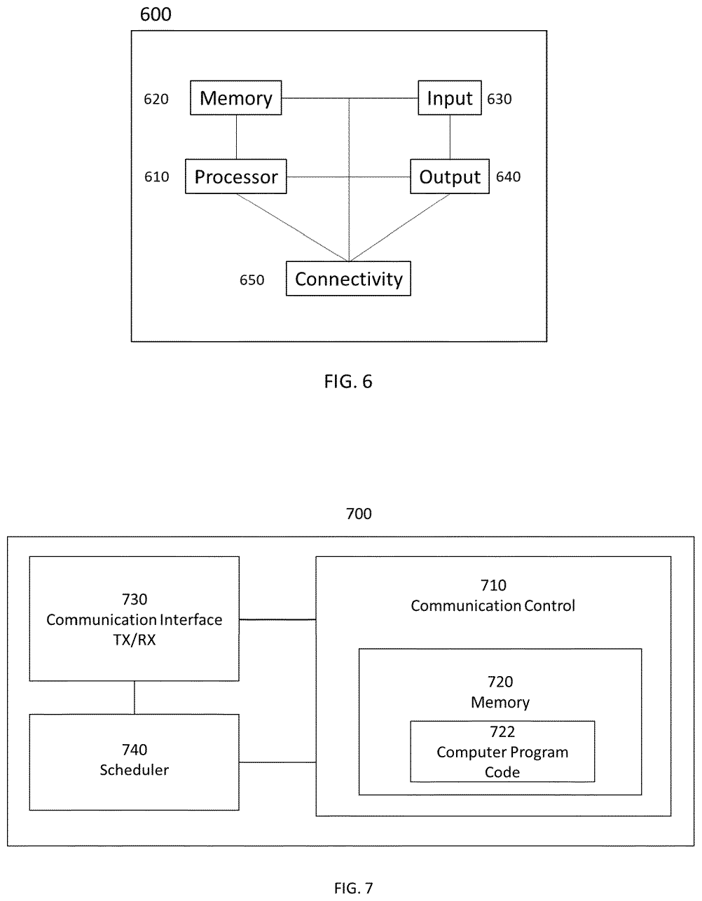

FIG. 6 illustrates an apparatus 600, which may be an apparatus such as, or comprised in, a terminal device, according to an example embodiment, and that may embody the activator or the reader as described above. The apparatus 600 comprises a processor 610. The processor 610 interprets computer program instructions and processes data. The processor 610 may comprise one or more programmable processors. The processor 610 may comprise programmable hardware with embedded firmware and may, alternatively or additionally, comprise one or more application specific integrated circuits, ASICs.

The processor 610 is coupled to a memory 620. The processor is configured to read and write data to and from the memory 620. The memory 620 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 620 stores computer readable instructions that are execute by the processor 610. For example, non-volatile memory stores the computer readable instructions and the processor 610 executes the instructions using volatile memory for temporary storage of data and/or instructions.

The computer readable instructions may have been pre-stored to the memory 620 or, alternatively or additionally, they may be received, by the apparatus, via electromagnetic carrier signal and/or may be copied from a physical entity such as computer program product. Execution of the computer readable instructions causes the apparatus 600 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 600 further comprises, or is connected to, an input unit 630. The input unit 630 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 630 may comprise an interface to which external devices may connect to.

The apparatus 600 also comprises an output unit 640. The output unit comprises or is connected to one or more displays capable of rendering visual content such as a light emitting diode, LED, display, a liquid crystal display, LCD and a liquid crystal on silicon, LCoS, display. The output unit 640 further comprises one or more audio outputs. The one or more audio outputs may be for example loudspeakers or a set of headphones.

The apparatus 600 may further comprise a connectivity unit 650. The connectivity unit 650 enables wired and/or wireless connectivity to external networks. The connectivity unit 650 may comprise one or more antennas and one or more receivers that may be integrated to the apparatus 600 or the apparatus 600 may be connected to. The connectivity unit 650 may comprise an integrated circuit or a set of integrated circuits that provide the wireless communication capability for the apparatus 600. Alternatively, the wireless connectivity may be a hardwired application specific integrated circuit, ASIC.

It is to be noted that the apparatus 600 may further comprise various component not illustrated in the FIG. 6. The various components may be hardware component and/or software components.

The apparatus 700 of FIG. 7 illustrates an example embodiment of an apparatus that may be an access node or be comprised in an access node, and that may embody the activator or the reader as described above. The apparatus may be, for example, a circuitry or a chipset applicable to an access node to realize the described embodiments. The apparatus 700 may be an electronic device comprising one or more electronic circuitries. The apparatus 700 may comprise a communication control circuitry 710 such as at least one processor, and at least one memory 720 including a computer program code (software) 722 wherein the at least one memory and the computer program code (software) 722 are configured, with the at least one processor, to cause the apparatus 700 to carry out any one of the example embodiments of the access node described above.

The memory 720 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus 700 may further comprise a communication interface 730 comprising hardware and/or software for realizing communication connectivity according to one or more communication protocols. The communication interface 730 may provide the apparatus with radio communication capabilities to communicate in the cellular communication system. The communication interface may, for example, provide a radio interface to terminal devices. The apparatus 700 may further comprise another interface towards a core network such as the network coordinator apparatus and/or to the access nodes of the cellular communication system. The apparatus 700 may further comprise a scheduler 740 that is configured to allocate resources.

Even though the invention has been described above with reference to example embodiments according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor, and at least one memory including a computer program code, wherein the at least one memory and the computer program code are configured, with the at least one processor, to cause the apparatus to:
determine, for a terminal device, a connection path, wherein the connection path comprises multiple radio links connecting an overlaying network and a subnetwork, and wherein the terminal device resides in the subnetwork;
obtain a management scheme for co-ordinating radio resource usage of the multiple radio links; and
cause radio resource control states of the radio links to be synchronized in accordance with the management scheme.

2. An apparatus according to claim 1, wherein the management scheme comprises information regarding one or more management operations for optimizing the radio links, such that activity periods of the radio links are co-ordinated to optimize transmission time for a data transmission performed using the radio links of the connection path, wherein the information comprises at least one of the following: timed instructions, timed recommendations, or a combination of timed instructions and timed recommendations.

3. An apparatus according to claim 2, wherein optimizing the transmission time comprises minimizing delays when performing the data transmission using the radio links, wherein minimizing the delays comprises synchronizing the activity periods of the radio links such that lengths of the delays are within pre-determined minimum and maximum values.

4. An apparatus according to any of claims 1 to 3, wherein the apparatus is further caused to adjust parameters of discontinued reception of the radio links to be synchronized in accordance with the management scheme.

5. An apparatus according to any of claims 1 to 4, wherein the apparatus is further caused to monitor activity within the at least one of the overlaying network or the subnetwork and provide data regarding the activity as an input for learning patterns of activity.

6. An apparatus according to claim 5, wherein the patterns of activity are used to modify the obtained management scheme.

7. An apparatus according to claim 5 or 6, wherein the learning is performed using machine learning.

8. An apparatus according to any previous claim, wherein the information regarding the set of management operations comprises at least one of the following: a set of policies expressing resource management optimization goals and instructions for performing resource management.

9. An apparatus according to any previous claim, wherein the management scheme is obtained, at least partly, from another device.

10. An apparatus comprising at least one processor, and at least one memory including a computer program code, wherein the at least one memory and the computer program code are configured, with the at least one processor, to cause the apparatus to:
obtain a first data, wherein the first data comprises information regarding radio resource usage in a first network;
obtain a second data, wherein the second data comprises information regarding radio resource usage in a second network, wherein the second network is different compared with the first network;
determine, based on the first data and the second data, usage patterns respective to the first network and the second network;
create, based on the usage patterns and a management profile, wherein the management profile defines an overall usage pattern of a plurality of networks, a first management scheme for the first network, and a second management scheme for the second network; and
distribute the first management scheme to the first network and the second management scheme to the second network.

11. An apparatus according to claim 10, wherein the first network is an overlaying network, and the second network is a subnetwork.

12. An apparatus according to claim 10 or 11, wherein the usage patterns are determined using machine learning.

13. An apparatus according to any of claims 10 to 12, wherein the first management scheme causes radio resource control states of radio links comprised in the first network to be synchronized in accordance with the first management scheme.

14. An apparatus according to any of claims 10 to 13, wherein the second management scheme causes radio resource control states of radio links comprised in the second network to be synchronized in accordance with the second management scheme.

15. An apparatus comprising at least one processor, and at least one memory including a computer program code, wherein the at least one memory and the computer program code are configured, with the at least one processor, to cause the apparatus to:
obtain information regarding a management scheme, wherein the management scheme is for co-ordinating radio resource usage of multiple radio links within a network and the apparatus resides in the network;
synchronize radio resource control state of a first radio link, from the apparatus to a communication point, in accordance with the obtained management scheme; and
transmit data using a communication path that comprises the first radio link and at least one other radio link and wherein the communication path connects the network to an overlaying network.

16. An apparatus according to claim 15, wherein the communication point is an access node.

17. A system comprising at least a first network, a first terminal device in the first network, a second network and a second terminal device comprised in the second network, and wherein the system is configured to:
obtain a first data, wherein the first data comprises information regarding radio resource usage in the first network;
obtain a second data, wherein the second data comprises information regarding radio resource usage in the second network;
determine, based on the first data and the second data, usage patterns respective to the first network and the second network;
create, based on the usage patterns and a management profile, wherein the management profile defines an overall usage pattern of a plurality of networks, a first management scheme for the first network, and a second management scheme for the second network;
distribute the first management scheme to the first network and the second management scheme to the second network;
synchronize, by the first network, radio resource control states of radio links comprised in the first network in accordance with the first management scheme;
synchronize, by the second network, radio resource control states of radio links comprised in the second network in accordance with the second management scheme; and
transmit, by the first terminal device, a data transmission to the second terminal device using a communication path comprising multiple radio links connecting the first network and the second network.

18. A method comprising:
determining, for a terminal device, a connection path, wherein the connection path comprises multiple radio links connecting an overlaying network and a subnetwork, and wherein the terminal device is comprised in the subnetwork;
obtaining a management scheme for co-ordinating radio resource usage of the multiple radio links; and
causing radio resource control states of the radio links to be synchronized in accordance with the management scheme.

19. A method comprising:
obtaining a first data, wherein the first data comprises information regarding radio resource usage in a first network;
obtaining a second data, wherein the second data comprises information regarding radio resource usage in a second network, wherein the second network is different compared with the first network;
determining, based on the first data and the second data, usage patterns respective to the first network and the second network;
creating, based on the usage patterns and a management profile, wherein the management profile defines an overall usage pattern of a plurality of networks, a first management scheme for the first network and a second management scheme for the second network; and
distributing the first management scheme to the first network and the second management scheme to the second network.

20. A method comprising:
obtaining information regarding a management scheme, wherein the management scheme is for co-ordinating radio resource usage of multiple radio links within a network and the apparatus resides in the network;
synchronizing radio resource control state of a first radio link, from the apparatus to a communication point, in accordance with the obtained management scheme; and
transmitting data using a communication path that comprises the first radio link and at least one other radio link and wherein the communication path connects the network to an overlaying network.

21. A computer program comprising instructions for causing an apparatus to perform at least the following:
determine, for a terminal device, a connection path, wherein the connection path comprises multiple radio links connecting an overlaying network and a subnetwork, and wherein the terminal device is comprised in the subnetwork;
obtain a management scheme for co-ordinating radio resource usage of the multiple radio links; and
cause radio resource control states of the radio links to be synchronized in accordance with the management scheme.

22. A computer program comprising instructions for causing an apparatus to perform at least the following:
obtain a first data, wherein the first data comprises information regarding radio resource usage in a first network;
obtain a second data, wherein the second data comprises information regarding radio resource usage in a second network, wherein the second network is different compared with the first network;
determine, based on the first data and the second data, usage patterns respective to the first network and the second network;
create, based on the usage patterns and a management profile a first management scheme for the first network and a second management scheme for the second network; and
distribute the first management scheme to the first network and the second management scheme to the second network.

23. A computer program comprising instructions for causing an apparatus to perform at least the following:
obtain information regarding a management scheme, wherein the management scheme is for co-ordinating radio resource usage of multiple radio links within a network and the apparatus resides in the network;
synchronize radio resource control state of a first radio link, from the apparatus to a communication point, in accordance with the obtained management scheme; and
transmit data using a communication path that comprises the first radio link and at least one other radio link and wherein the communication path connects the network to an overlaying network.
